(19) United States
(12) Patent Application Publication
(10) Pub. No.: US 2004/0034460 A1
(43) Pub. Date: Feb. 19, 2004

(54) Powertrain control system

(76) Inventors: Charles Henry Folkerts, Troy, MI (US); Kenneth Paul Dudek, Rochester Hills, MI (US); Gregory Paul Matthews, West Bloomfield, MI (US); William Burton Orrell, Hartland, MI (US); Michael Livshiz, Ann Arbor, MI (US)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 10/218,113

(22) Filed: Aug. 13, 2002

(51) Int. Cl. G06F 19/00

(52) U.S. Cl. 701/54; 701/51

(57) ABSTRACT

A coordinated torque control system for a vehicle including a powertrain controller, a vehicle control integration control module contained in the powertrain controller, a powertrain control integration module communicating with the vehicle control integration control module, a power generation and transfer module communicating with the powertrain control integration module, and where the powertrain control integration module may be programmed independent of the powertrain control technology used in the vehicle.

### TECHNICAL FIELD

The present invention relates to a vehicle control system. More specifically, the present invention relates to a method and apparatus to control the powertrain of a vehicle.

### BACKGROUND OF THE INVENTION

Presently, automotive companies manufacture a wide range of vehicle powertrains such as internal combustion engines (ICEs), electric vehicles powered by fuel cells and battery packs, and hybrid vehicles having multiple powertrain components arranged in serial or parallel configurations. ICE-powered vehicles and hybrid vehicles are typically equipped with an automatic or manual transmission and all vehicle powertrain technologies incorporate powertrain controllers. Powertrain or engine and transmission controllers in modern vehicles are equipped with inputs/outputs (I/O) and software that is used to control the vehicle and powertrain. The software in modern controllers is generally vehicle and powertrain specific and must undergo extensive modifications to be utilized with alternate propulsion systems such as hybrid powertrains. A vehicle manufacturer is required to maintain a software library for a variety of vehicle models and powertrains, generating infrastructure costs and complexity.

### SUMMARY OF THE INVENTION

The present invention is a method and apparatus for providing a powertrain control system that may be utilized on any technology specific powertrain with only relatively small modification. The software architecture or structure of the present invention includes plug-and-play software modules that seamlessly transfer information according to predefined inputs and outputs (I/O). The modular software is structured to de-couple vehicle powertrain control functions. When vehicle control systems, subsystems or modules are coupled they tightly interact with each other. Thus, when the performance of one subsystem is modified by changing the calibration of its parameters, then the performance of another subsystem is impacted. This results in an iterative calibration process to converge on a desired performance for the total integrated system. However, when subsystems are de-coupled, then the calibration of one subsystem can be carried out relatively independent of the other interconnected subsystems.

The modular structure of the control system of the present invention decouples vehicle powertrain control such as for an ICE, transmission, and/or electric motor to limit interaction and allow the controls and powertrain to operate in concert toward a common goal of providing the desired vehicle performance trajectories comprising any combination of the variables torque, acceleration, jerk, speed, and/or power. The de-coupled structure simplifies the calibration process by permitting the vehicle and powertrain controls to be calibrated with minimal interaction. The modular software architecture and structure of the control system of the present invention is generalized to support alternate propulsion systems with maximal reuse of control or software modules and other algorithms. The control system of the present invention is designed to support the ability to plug-and-play ICE and transmission control software, fuel cell and battery powered electric vehicle control software, hybrid vehicle control software, and other powertrain control software and systems. Thus, it will be possible to mix and match previously calibrated engines and transmission or electric powertrains with relatively minimal recalibration or no recalibration and minimal new software.

A second advantage of the modular structure of the present invention is that a high level partitioning of the functions is formed such that software from a third party such as an automotive software supplier can be more easily integrated into the software of an original equipment manufacturer (OEM) of powertrains. The software supplier generates the software modules with respect to a functional specification and predefined input and output variables. The high level partitioning provides an OEM with the option to purchase large algorithmic functional units for faster integration and production introduction of new hardware or software features, without the need to purchase entire control systems. The partitioning gives the OEM more options when developing new powertrains controls and propulsion systems and allows the OEM to introduce new features and technologies faster without significant development time and costs.

In the present invention, the powertrain is viewed by the vehicle control systems as a torque or power generation servo that delivers torque or power to propel the vehicle. The powertrain controls view the power generation unit (engine and its control system in a conventional powertrain) as a torque or power servo that operates in concert with a power transfer unit (transmission and its control system in a conventional powertrain), operating as a ratio servo to modify the torque or power. In the software architecture of the present invention, the architecture is not propulsion system technology specific. The software is partitioned according to the fundamental physical variables that define the performance of a vehicle and propulsion system such as torque, speed, acceleration, jerk and/or power. The interface or actuator variables for the higher levels of the present control system are independent of the hardware technology used to produce the torque, such as spark, air, fuel, EGR, clutch pressures and/or other similar variables. The actuator variables are specific to the power generation and transfer technologies used and are controlled in the present control system. The actuator variables are at the lowest level of the system where they have the least impact on the integration of the larger functional blocks.

The modular de-coupled nature of the present powertrain control system more readily allows development and application of control-theory based algorithms for estimation, prediction, control and diagnostics to significantly improve the relative performance of the overall system. Specifically, the application of model-based estimation and prediction throughout the control system provides the ability to coordinate the performance of all of the elements in the control system. The performance of the powertrain control system of the present invention can be controlled and diagnosed by controlling and diagnosing the performance of the individual software components, in such a manner that they act in concert to achieve the overall desired system performance. By estimating and predicting key state variables (such as torque, acceleration, jerk, speed, and/or power) and system parameters, and then using these key state variables and parameters in control, the system can be accurately controlled to have a desired performance in terms of state-variable response-trajectory shapes, fuel economy, and emissions. Accordingly, each software module of the present invention is controlled precisely to provide a required response and performance that supports the desired response and performance of the total system. The modular and de-coupled software architecture or structure of the present powertrain control system results in the ability to divide and conquer the control of the total system into several smaller problems for precisely controlling individual components.

The software architecture of the present invention also permits an OEM to respond to rapidly changing marketing trends and technology developments. Due to the open, de-coupled, modular, and plug-and-play structure of present software architecture, alternate propulsion technologies such as hybrid vehicles and fuel cell or battery powered electric vehicles are more easily and quickly integrated into a vehicle powertrain with minimal changes required. Accordingly, if the engine or power generation technology needs to be changed in a vehicle then the fundamental control system architecture will not need to be changed. The powertrain control system of the present invention may be used with any type of propulsion system with a relatively small amount of rework. In addition, the application of estimation and prediction of key variables and parameters enables the vehicle performance to be shaped precisely, and the software modules to be diagnosed independently.

### BRIEF DESCRIPTION OF THE DRAWINGS

FIG. 1 is a diagrammatic drawing illustrating the high level architecture of the present invention.

FIG. 2 is a diagrammatic drawing illustrating a detailed architecture of a preferred embodiment of the present invention.

### DESCRIPTION OF THE PREFERRED EMBODIMENT

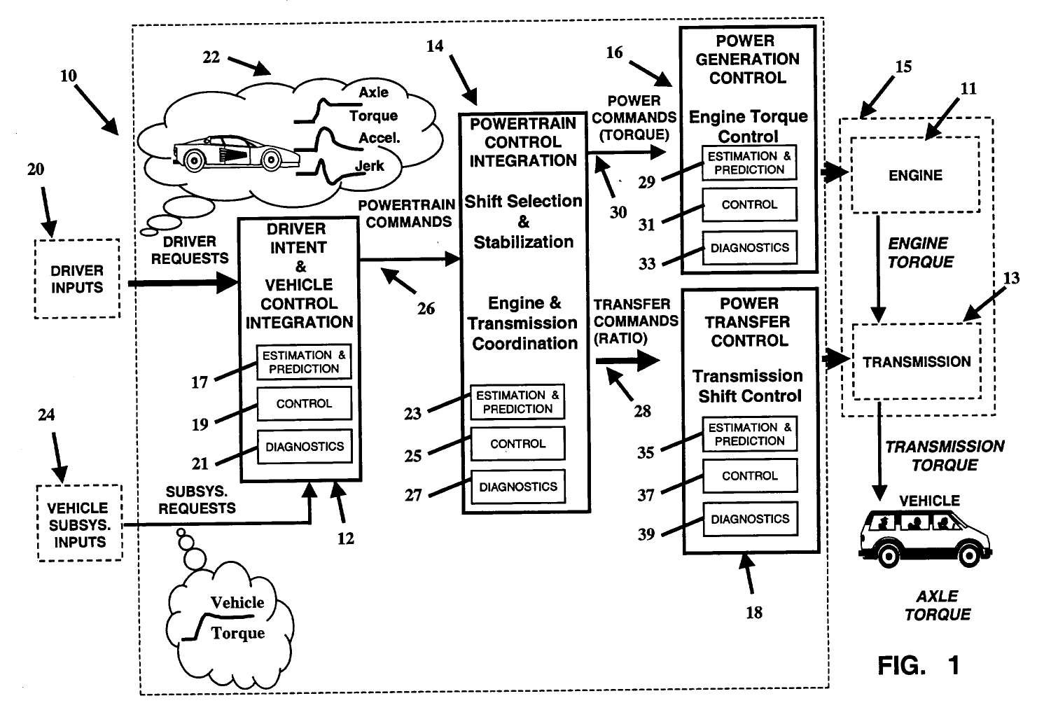

FIG. 1 illustrates the hierarchical modular software architecture or structure of the control system 10 for a powertrain 15 of the present invention. FIG. 1 is diagrammed such that the highest level of vehicle control decisions are made at the left of FIG. 1 and the lowest level of decisions are made at the right of FIG. 1. If the source of power 11 or power transfer apparatus 13 (if required) of the powertrain 15 is changed to an alternate technology, then the control software most impacted will be at the lowest level of control. In the preferred embodiment of the present invention the source of power 11 is an ICE and the power transfer apparatus 13 is an automatic transmission, but any power device such as a series/parallel hybrid ICE/electric powertrain or an electric motor powered by fuel cells or batteries is within the scope of the present invention.

The control at the higher levels of the control system 10 will need no changes or minimal changes such as in calibration to operate with multiple sources of power. Higher levels of control in the present invention are not involved in the specific details about power transfer to the vehicle supplied by the powertrain 15. The higher level controls are involved with the high-level performance capabilities of the system, as will be described in this specification.

The control system software of the present invention is executed and stored in a vehicle, powertrain, engine, and/or transmission controllers. The software architecture is independent of the physical implementation of the controller hardware. Execution of the software may be implemented in a distributed computing environment with all or different portions of software being executed in the vehicle, powertrain, engine, and/or transmission controllers. The vehicle control functions may be distributed among several controllers such chassis, traction, vehicle stability, braking, steering, and/or body controllers. The choice of the distribution of the execution varies from application to application based on hardware availability, constraints and requirements. The following description assumes that all of the software is executed in a vehicle controller. The vehicle controller may be any known microprocessor or controller used in the art of engine or powertrain control.

In the preferred embodiment of the present invention, the vehicle controller is a microprocessor, having input/output (I/O), nonvolatile memory (NVM) such as read only memory (ROM), electrically erasable ROM (EEPROM), or flash memory, random access memory (RAM), and a central processing unit (CPU). The vehicle controller also includes calibration constants stored in NVM that may be applied to control numerous powertrain types. The vehicle controller may communicate with vehicle systems using discrete I/O, analog I/O, and/or an automotive communications network including, but not limited to, the following commonly used vehicle communications network standards: CAN, SAE J1850, and GMLAN.

In the present invention, control decisions made at the level of the driver and vehicle in the vehicle control integration block 12 are substantially independent of what technologies are used to generate the torque or power for the powertrain 15. The control decisions are based on the requirements and/or requests of the driver 20 and the vehicle subsystems 24, and are limited by the performance constraints that were established for the specific market segment and/or the application that the vehicle and powertrain 15 were designed to satisfy. All that is needed at the vehicle integration level of block 12 (to describe the powertrain technologies used) is a capability model of the vehicle and powertrain 15, which is a high-level model of the performance capabilities of the vehicle and powertrain 15, as viewed as a total system.

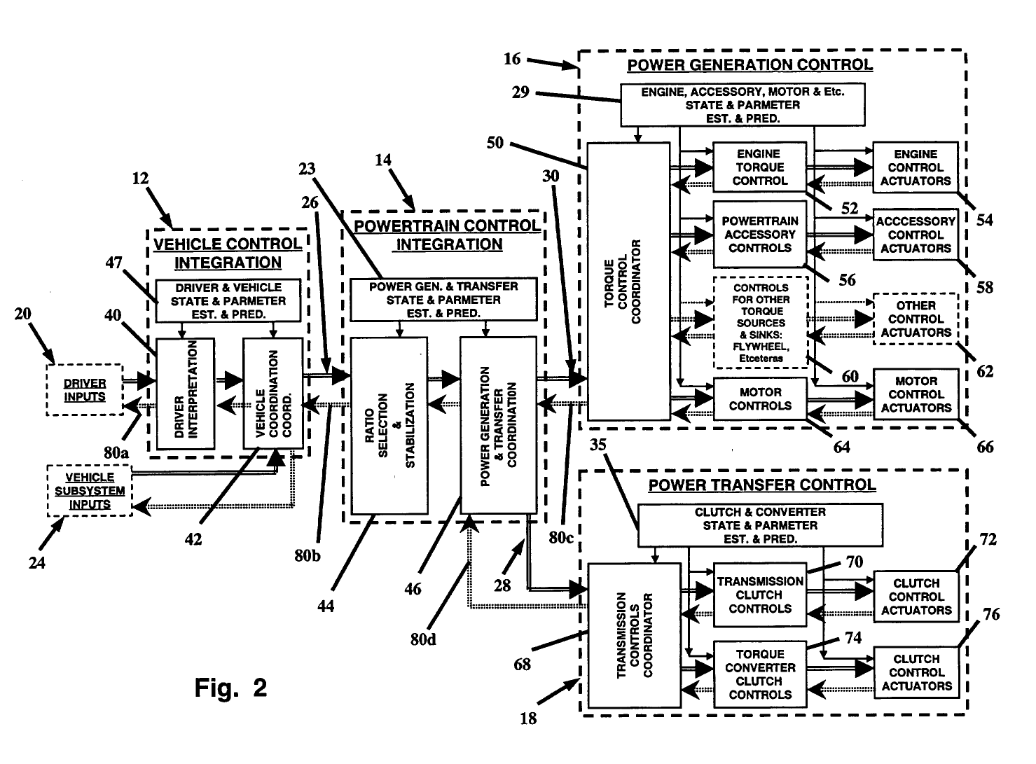

The vehicle control integration block 12 further includes estimation and prediction reference models 17, control software 19, and diagnostics software 21. The estimation and prediction models 17 shape or smooth a generated torque or power command 26 based on the interpretation of the driver's inputs and the vehicle subsystems' inputs. The estimation and prediction reference models 17 are used to define: (1) the required torque or power command trajectories, and (2) the expected (or desired) performance trajectories 22 of vehicle torque, speed, acceleration, jerk and/or power based on the current estimate of the system parameters (such as vehicle mass, friction, and road load) and other state variables. The control software 19 uses feedback and/or adaptive control to ensure that: (1) the vehicle performance meets the expected (or desired) performance trajectories, or (2) the prediction reference model matches the performance of the vehicle. The amount of correction provided by the control software 19 is an indication of how far the vehicle's performance has strayed from the nominal designed behavior. The control software 19 will be described in more detail with reference to FIG. 2.

The diagnostics software 21 uses the information (feedback and/or adaptive correction) from the control software 19 as an indication of the proper functioning of the vehicle. If the control software 19 provides a relatively large amount of correction, then the system is not functioning as designed and further diagnostic software will be executed to isolate the problems and the driver will be notified to take the vehicle to a service shop for evaluation. This model-based control approach enables problems to be captured before they would result in a hardware failure.

The next highest level of decision-making in the software architecture of the present invention is the powertrain level of control at powertrain control integration block 14. The powertrain control integration block 14 receives the powertrain commands 26 from block 12, including the torque or power command, and the expected performance trajectory responses (torque, acceleration, jerk, speed and/or power) predicted by block 17. Powertrain block 14 makes decisions on how to efficiently deliver the requested power within the constraints of the powertrain 15. The powertrain control software in block 14 decides how much torque or power needs to be generated by power generation control unit 16 and what gear ratio needs to be provided by power transfer control unit 18 (if one is present) to deliver it in an efficient and pleasing manner within the constraints and limitations of the powertrain 15 design.

The powertrain software and controls of block 14 coordinate torque generation with the gear ratio change of a transmission 13 such that the performance during the ratio change is controlled to meet requirements for the specific vehicle application or situation. The powertrain control block 14 uses information on the high level performance capabilities (capability models) of both the power generation and power transfer technologies, but does not require information on the technological details of how the power is generated and transferred.

The powertrain control integration block 14 further includes estimation and prediction reference models 23, control software 25, and diagnostics software 27. The estimation and prediction reference models 23 shape or smooth power transfer commands 28 and torque power generation commands 30 based on the powertrain commands 26. The estimation and prediction reference models 23 are coordinated with the estimation and prediction models 17 at the vehicle level, such that they shape the power generation commands 30 and the power transfer commands 28 in a fashion necessary to generate the vehicle response defined by the estimation and prediction reference models 17. The outputs of the estimation and prediction models 23 are the torque or power commands and the expected performance trajectories for the power generation control unit 16, and the torque transmission ratio trajectories for the power transfer control unit 18.

The control software 25 uses feedback and/or adaptive control to ensure that: (1) the torque generation and ratio change performance meets the expected (or desired) performance trajectories, or (2) the prediction reference model matches the performance of the torque generation and ratio change. The amount of correction provided by the control software 25 is an indication of how far the ratio change performance has strayed from the nominal designed behavior. The control software 25 will be further described in detail in FIG. 2.

The diagnostics software 27 uses the feedback and/or adaptive correction information from the control software 25 as an indication of the proper functioning of the torque generation and the shift. If the control software 25 provides a large amount of correction (or control action), then the system is not functioning as designed and further diagnostic software will be executed to isolate the problems and the driver will be notified to take the vehicle to a service shop for evaluation. This model-based control approach enables problems to be captured early before they would result in a hardware failure.

The lowest level control system decision making is at the right hand side of FIG. 1, where power generation block 16 and a power transfer block 18 are controlled by the power transfer commands 28 and power generation commands 30. At this level, the controls software or systems utilize the specific details of how a specific technology delivers the power. Although the controls software and systems at this lowest level are tailored to the specific details of the powertrain technology used, they can also be structured in a modular fashion to minimize the impact of changing subsystem technologies. Under the powertrain control system 10 of the present invention, the majority of the system components can be reused to support any technology with the addition or deletion of smaller modular control system components as needed to support specific technologies. The power generation block 16 and power transfer block 18 (if required) are designed to support alternate power generation technologies such as multi-point fuel-injected spark-ignited engines; diesel engines; electric and hybrid powertrains; and battery and fuel cell powered electric vehicles. If the power generation technology requires a transmission, alternate power transfer technologies or transmissions such as stepped gear, continuously variable, infinitely variable, automated manual, and manual transmissions may be seamlessly integrated into the control system 10 of the present invention. Ultimately, the powertrain 15 will be controlled by the power generation block 16 and, in powertrains where a transmission is present, the power transfer block 18.

The power generation block 16 further includes estimation and prediction reference models 29, control software 31, and diagnostics software 33. The estimation and prediction models 29 produce control variable trajectories based on the power command trajectory 30. The estimation and prediction reference models 29 are coordinated with the estimation and prediction models 23 at the powertrain level, such that they shape the control variable trajectories in a fashion necessary to cause the vehicle response defined by the estimation and prediction reference models 17. The outputs of the estimation and prediction models 29 are the trajectories of the control variables required by the power generation unit to produce the desired power commands.

The control variable trajectories include the required trajectories of all of the variables that control the production of the torque or power. For example, in a conventional ICE the control variable trajectories include, but are not limited to, the mass of air, fuel and residual exhaust gas needed in the cylinder to produce the desired torque. In a conventional ICE, the control software 31 adjusts the control actuators of throttle angle, spark angle, fuel injector pulse width, EGR valve position, and other similar actuators to insure that the control variable trajectories are achieved. The control software 31 uses feedback and/or adaptive control to ensure that: (1) control variable trajectory performance meets the expected (or desired) performance trajectories, or (2) the prediction reference model matches the performance. The amount of correction provided by the control software 31 is an indication of how far the performance has strayed from the nominal designed behavior.

The diagnostics software 33 uses the feedback and/or adaptive correction information from the control software 31 as an indication of the proper functioning of the engine. If the control software 31 provides a large amount of correction (or control action), then the system is not functioning as designed and further diagnostic software will be executed to isolate the problems and the driver will be notified to take the vehicle to a service shop for evaluation. This model-based control approach enables problems to be captured early before they would result in a hardware failure. In addition, the diagnostic software 33 may be used to perform corrective or remedial control actions that provide reduced system performance or capability. The reduced capability of the hardware is feedback to the higher levels of the system through the feedback signals 80. Accordingly, the overall performance of the system would be adjusted appropriately to accommodate the performance limitations of the hardware and the whole system would perform in a coordinated fashion.

The power transfer block 18 further includes estimation and prediction reference models 35, control software 37, and diagnostics software 39. The estimation and prediction models 35 produce control variable trajectories based on the torque transfer command trajectories 28. The estimation and prediction reference models 35 are coordinated with the estimation and prediction models 23 at the powertrain level, such that they shape the control variable trajectories in a fashion necessary to cause the ratio change response defined by the estimation and prediction reference models 17. The outputs of the estimation and prediction models 35 are the trajectories of the control variables required by the torque transfer unit 18 to produce the desired ratio change and torque transfer commands 28. The control variable trajectories include the required trajectories of a plurality of the variables that control the production of the torque during the shift. For example, in a conventional stepped-gear transmission, the control variable trajectories would include the line and clutch pressure profiles needed to transfer the desired torque during the shift. In a conventional stepped-gear transmission, the control software 37 would adjust the control actuators of line pressure-valve position and shift-valve positions to insure that the control variable trajectories of clutch hydraulic pressures are achieved

The control software 37 uses feedback and/or adaptive control to ensure that: (1) the ratio change performance meets the expected (or desired) performance trajectories, or (2) the prediction reference model matches the performance of the ratio change. The amount of correction provided by the control software 37 is an indication of how far the ratio change performance has strayed from the nominal designed behavior.

The diagnostics software 39 uses the feedback and/or adaptive correction information from the control software 37 as an indication of the proper functioning of the shift. If the control software 37 provides a large amount of correction (or control action), then the system is not functioning as designed and further diagnostic software will be executed to isolate the problems and the driver will be notified to take the vehicle to a service shop for evaluation. As described previously, this model based control approach enables problems to be captured early before they would result in a hardware failure.

FIG. 2 illustrates a first embodiment of the present invention illustrating the driver interpretation or intent function of block 12 using the driver inputs or requests 20. The driver inputs or requests 20 include, but are not limited to an accelerator pedal position and/or rate of change, a brake pedal force and/or rate of change, cruise control inputs, gear selection, clutch positions, and/or driving mode selection buttons (such as a sport/economy button, trailering/hauling button, and/or winter driving buttons) to determine the desired performance that the driver is requesting. The driver request is interpreted as a desired vehicle performance by a driver interpretation block 40, which can be expressed as desired time-trajectories of vehicle acceleration, jerk, velocity, torque, and/or power depicted by plots 22 in FIG. 1. This desired performance is converted into a request for the powertrain 15 to deliver the response necessary to meet the driver's expectations. The integration of the driver and vehicle level functions in the vehicle control integration block 12 allows the powertrain 15 to be viewed as a servo-system that will deliver the requested commands to the vehicle according to a trajectory with the desired shape.

Over the operation and lifetime of the vehicle, the driver interpretation function can be modified through feedback 80b, such that the driver is prevented from commanding the vehicle to do something that the powertrain 15 is incapable of delivering. Under these situations, the driver may be notified of the reduced performance via visual and/or audible feedback 80a. As the performance capabilities of the vehicle and/or powertrain system degrade, the driver may also be advised to take the vehicle in for service by using feedback 80a. Additionally, the vehicle controller may request a diagnostic analysis to be performed through feedback 80a to a telematics system (such as OnStar®) that diagnoses the problem and makes corrections, or advises the driver to seek service and assists the driver in making a service appointment.

The driver's performance may be monitored by the driver state estimation and prediction functions of block 17, previously described with reference to FIG. 1. Block 17 contains a model of the driver's response or performance that has been learned over a period of time. By comparing the driver's response or performance to the learned model, a feedback control in block 17 may be established to make the model track the driver's current performance. The size of correction needed by the feedback and/or adaptive control to make the model match the driver's current performance may be used to adjust or restrict the driver's control of the vehicle to compensate for reduced performance or reaction time (due to driver impairment). Using this control correction information, the driver diagnostic function of block 17 may notify the driver of the reduced performance via visual and/or audible feedback 80a. Additionally, the diagnostics could trigger the telematics system to respond with an appropriate action.

At the same time that the driver is making demands on vehicle performance, the vehicle subsystem inputs or requests 24 such as an antilock brake system (ABS), traction control system (TCS), vehicle stability controls (VSC), drag control system (DCS), brake control system (BCS), adaptive cruise control system (ACC), and/or cruise control system are monitoring the vehicle performance and also making performance requests. The vehicle subsystem requests 24 under certain conditions will modify or override the driver requests 20. The subsystems may request a desired vehicle performance, which can also be expressed as desired time-trajectories of acceleration, jerk, velocity, torque and/or power. When the vehicle subsystem requests 24 are different from or contradict the driver requests 20, the requests must be arbitrated.

The vehicle control integration block 12 executes a vehicle coordination function in block 42 that receives the driver and vehicle subsystem requests 20, 24 and performs the arbitration between the requests to determine what performance function or request should be sent to the powertrain 15. This function also compensates (within limits) for any losses or limitations imposed by the vehicle (such as mass, tire radius, aerodynamic losses, driveline losses, 4WD/AWD transfer case losses, maximum vehicle speed, and/or other similar variables), environment (such as road grade, road surface friction, and/or other similar variables) or hardware (such as drive-line losses, maximum torque limitations, and/or other similar variables) in delivering the requested performance from the powertrain 15 to the vehicle. In addition, the arbitration function will not request the powertrain 15 to deliver anything that is beyond its capabilities.

The vehicle coordination block 42 includes a high-level capability model of the powertrain 15, which is contained in block 17, to limit the commands that it will give to the powertrain 15. The capability model is initially set to the known performance a specific powertrain 15, but may be changed over the operation and lifetime of the vehicle through feedback 80b from the powertrain 15. Once the arbitration and limiting is completed, the vehicle state estimation and prediction block 17 along with the control block 19 will further modify the performance request, and the performance request will be provided to the powertrain control integration block 14 as the torque request or power command 26, which may include vehicle torque, power, speed, acceleration and/or jerk specifications.

Referring to FIG. 1, the vehicle state estimation and prediction elements of block 17 contains mathematical models (reference models) that define the desired vehicle performance in terms of vehicle torque, power, speed, acceleration and/or jerk. The control functions of block 19 will make corrections to the performance request by comparing the desired performance to the actual performance through a feedback control mechanism (such as PID control, fuzzy control, neural network control, adaptive, or any other feedback control theory). Accordingly, the feedback control will cause the actual vehicle performance to match the desired performance. Alternatively, if maintaining vehicle performance through closed-loop control is not desired, the feedback control may be used to make the reference models of the estimation and prediction block 17 match the actual vehicle performance for the sole purpose of diagnosing system failures or degradation.

The vehicle feedback control function of block 19 may also include adaptive control or learning schemes to compensate for systematic errors or biases (that are the result of system aging and system-to-system differences from manufacturing variation). The adaptive control will reduce the correction required by the feedback control to bring the system back to the desired performance. Alternatively, the adaptive control may be used to bring the reference model back to the actual performance for the sole purpose of diagnosing system failures or degradation. Based on the size of both the learned and feedback corrections, the vehicle diagnostic functions in block 21 are able to determine if the vehicle is performing to desired specifications or whether the vehicle needs servicing. The diagnostic functions of block 21 also use diagnostic feedback information from the diagnostic functions of blocks 27, 33, and 39 to isolate the sources of problems or component failures. Accordingly, the diagnostics in block 21 may determine if a change in performance is due to changes in the vehicle system (such as tire pressure, tire tread condition, drive-line losses, lubrication, and/or other similar measurements) as opposed to the engine, transmission, or other power generation hardware (such as accessories, electric motor, flywheel, or other sources or sinks of torque). Once a problem is diagnosed, the diagnostic software takes corrective or remedial action to eliminate or minimize the problem, the driver is informed that the vehicle needs servicing through visual or audible feedback, and/or the telematics system (such as OnStar®) is enabled to provide further assistance as needed.

To carry out the vehicle state estimation and prediction function of block 17 more accurately, block 17 may include a road load estimation function. The road load estimation model provides information about the current state of the road grade, vehicle mass, rolling resistance, tire losses, tire rolling radius, aerodynamic losses, and/or viscous losses through the drivetrain. The model information predicts the performance of the vehicle and provides the required control response of the powertrain to the driver's commands. For example, a vehicle on grade or a heavier vehicle would require more power to achieve a desire response.

In addition, the functions of block 17 may be used to determine the driver's driving style and the driving situation. Style may be classified over a spectrum of classifications from conservative to high performance. Driving situation may be classified over a range of situations from urban stop-and-go to highway cruising, over a range of road conditions from rough to smooth, and over a range of environments such as snow, rain, and dry. By estimating parameters in a driver model, the driving style may be classified to determine if the driver prefers a more or less aggressive vehicle feel, which is used to adjust pedal feel, shift schedules, shift quality, and other similar systems to provide the desired vehicle responsiveness. The driving situation and environment may be classified by estimating parameters in the driving situation and environment models of block 17. Using the estimation models of block 17 for driver style, road condition, driving environment, vehicle state, and road load, block 17 will determine the appropriate driving style to provide for the driver to meet his needs and the demands of the current driving situation.

Referring to FIG. 2, the powertrain control integration function of block 14 receives the torque or power commands 26 from the vehicle control integration block 12 and performs two major functions on the command 26: ratio selection and stabilization (if a transmission is included in the powertrain 15) at block 44, and power generation and transfer coordination at block 46. The powertrain control integration function of block 14 determines the required transmission gear ratio necessary to deliver or achieve the requested response from the vehicle, while balancing fuel economy and performance goals with powertrain system limitations.

The ratio and stabilization function of 44 determines the required gear ratio based on a balance of requirements such as: driver type, road conditions, road load, driving situation, optimal powertrain efficiency, please-ability (shift busyness), and hardware limitations such as failure modes, torque generation capability, speed limitations, torque transfer capacities, noise, vibration, and/or harshness. The ratio command includes the gear ratio, and the state of the torque converter clutch (slip or locked), if one exists. The ratio command or power transfer commands 28 generated by block 14 are evaluated for stability to prevent shift busyness by ensuring that the gear change will provide enough capability for a reasonable period of operation to avoid doing a shift and then immediately undoing it.

The stabilization of a shift is accomplished through the state estimation functions of block 23 previously described with reference to FIG. 1. Block 23 estimates or predicts the future state of the vehicle by using the vehicle parameters previously estimated in block 17, and the commanded powertrain output torque or power from the powertrain commands 26. With this information the stabilization algorithm can evaluate the impact of changing the commanded gear ratio by calculating the required gear ratio and reserve torque that will be available at some point in time in the future after the proposed ratio command is executed. By comparing the proposed gear or ratio change with the future predicted gear ratio requirement, a decision can be made to implement the current proposed gear or ratio change, or to override it to avoid or control shift busyness.

Once the ratio command 28 is determined, then the ratio command 28 is coordinated with a power generation function block 16 through a power generation command 30. The coordination between the ratio command 28 and the power generation command 30 is accomplished through the power generation and transfer coordination function of block 46. Block 46 commands the power generation function to change the torque production such that the change in torque coincides with the load change that results from the ratio or gear change. Block 46 performs the coordination by properly synchronizing the power generation command 30 (given to the power generation function 16 to change the torque) with the ratio change command 28 (given to the power transfer function 18 to change the ratio or gear). This results in the performance of the shift being controlled for good driveability by properly shaping the desired time-trajectories of acceleration, jerk, velocity, torque, and/or power during the ratio change with reference to the state estimation and prediction models of block 23.

The estimation and prediction models of block 23 are used to dynamically predict and shape the transient performance during a transmission shift by commanding trajectories or engine torque and engine speed during the shift. The control function of block 25 uses feedback control to either drive the actual performance to the desired performance or to make the reference models of the estimation and prediction block 23 match the actual performance. Diagnostic software of block 27 uses the amount of feedback and/or adaptive correction from block 25 to either compensate for aging or to notify the driver that repair or maintenance is required.

Block 46 also compensates for any losses or gains in the power transfer function (such as transmission gear losses and torque converter gains) to ensure that the power generation function delivers enough power, such that the performance requested at the vehicle level is achieved. To ensure that the shift is accomplished correctly, block 46 also provides block 18 with the amount of torque or power that the unit must transfer to the vehicle.

In addition to controlling the shift, the power generation and transfer coordination function of blocks 44 and 46 also shape performance commands to the power generation function 16 to ensure that the desired time-trajectories of acceleration, jerk, velocity, torque, and/or power is achieved at the vehicle level. In order to shape performance trajectories, the power generation and transfer coordination function of block 46 contains high-level capability models of both the power generation function and the power transfer function, which are contained in block 23. These capability models are initially set to the known performance of power generation 16 and power transfer functions 18 used, but may be changed over the operation and lifetime of the vehicle through feedback 80c and 80d from both the power generation and power transfer functions. Block 16 is used to perform this function of controlling performance when a shift is not required. However, using block 46 to shape performance continuously rather than only during shifts reduces overall system complexity, as the control of the shifts would also require the power generation and transfer coordination function of block 46 to contain capability models of the power generation 16 and the power transfer functions 18.

The power generation function of block 16 receives the performance commands for the desired time trajectories of acceleration jerk, velocity, torque, and/or power from the power generation and transfer coordination block 46 of block 14. Block 16 converts these high-level commands into the required low-level commands (such as throttle position and spark advance for an ICE, a voltage and/or current command for an electric motor, and/or other control variables for other sources or sinks of torque) that provide the desired vehicle level performance. Before block 16 converts the command 30 to low level commands, it compensates for any losses (such as friction or accessory loads) that are incurred in the power generation function, such that the vehicle output acceleration, jerk, velocity, torque, and/or power will provide the performance desired or requested at the vehicle level.

The power transfer function of block 18 is a ratio servo-system. It receives the performance command or commands 28 from the power generation and transfer coordination function of block 44 and ensures that the ratio or gear change occurs at the right time to transfer the power necessary to achieve the desired vehicle performance. Block 18 converts these high-level commands 28 into the required low-level commands such as transmission hydraulic line pressure, clutch pressures, solenoid voltages and currents to sequence the appropriate clutches and ensures that the clutch pressure is sufficient to transfer the power to the output shaft of the power transfer device with the desired performance. Block 18 also performs the ratio change according to a desired trajectory, such that the desired performance feel is provided to the driver.

Integrated within the power generation function of block 16, the control system is organized to utilize multiple sources or sinks of power or torque. Block 16 includes: a torque control coordinator block 50 that decides how much power or torque each of the various power or torque sources must deliver in order to deliver the required vehicle performance trajectories of power, torque, acceleration, velocity, and/or jerk; an ICE torque control block 52 to control engine control actuators 54 such as an electronic throttle, spark, exhaust gas recirculation (EGR), cylinder cut-off, and/or fuel injectors; a powertrain accessory control block 56 to control accessory control actuators 58 such as electrical switches or power drivers that actuate accessories such as the air conditioner and/or alternator loading (by modulating or turning on or off electrical loads); a control block 60 for controlling other torque sources and sinks (such as flywheel, and regenerative braking) by control actuators 62 such as electrical switches or power drivers that actuate sources and sinks of torque such as flywheels and regenerative braking; and an electric motor control block 64 for controlling electric motor actuators 66 such as electric power drive circuitry to control the electric motor current and/or voltage waveforms.

In addition, block 16 contains the state estimation and prediction block 29 that predicts key or essential variables or state variables to enable each of the power or torque sources or sinks to accurately deliver their portion of the power or torque required to meet the desired vehicle performance. Block 29 has a separate estimation and prediction function associated with each power or torque source or sink. These estimation and prediction functions may be incorporated with the control of each of the sources or sinks. Block 29 estimates and predicts the state of the essential variables of each of the power or torque sources or sinks through an algorithm that uses information from the sensors and actuators for each of the sources or sinks. For example, in an ICE, block 29 would estimate and predict the mass of air trapped in the cylinder at the current and next cylinder firing, the mass of fuel in the cylinder, the mass of exhaust gas trapped in the cylinder, and the torque generated. The state estimation and prediction algorithm for the mass of air in the cylinder uses inputs of throttle position, manifold absolute pressure (MAP), mass air flow, engine speed, and cylinder air temperature.

The ICE control and diagnostic functions of the engine torque control block 52 use the mass of air in a cylinder in combination with the commanded torque, and other estimated and predicted state variables of the engine, to determine the required throttle position commanded to the engine control actuator of an electronic throttle in block 54. The estimated and predicted variables are used by the closed-loop control and diagnostic functions of block 52 to determine system failure modes (such as air leaks in the air intake system), to take corrective action (such as shutting off fuel and spark to cylinders, or retarding, spark advance), and to tell the driver to seek service (by setting a service engine soon light).

The engine control actuator function of block 54 provides the control and diagnostic functions necessary to ensure the commands from block 52 are delivered as accurately as necessary. Block 54 represents the lowest level of the present control system and is tied to the specific technology used to actuate the engine control variables. In order to accomplish its functions, block 54 also utilizes the state estimation and prediction functions of block 29. In the case of an electronic throttle system, block 54 includes feed forward, feedback, and/or adaptive control algorithms (as is commonly known to anyone trained in the art) to ensure that the desired throttle position accuracy and trajectory are achieved. For the electronic throttle control system, the controls of block 54 measure the throttle position and adjust the voltage and current applied to the motor actuator in order to control the position of the throttle. Similarly, block 29 for an electric motor estimates and predicts current and future values of critical state variables such as winding current, voltage, speed, acceleration, jerk, torque, power generated (based on current and past values of winding current), voltage, motor temperature, battery state of charge, speed, acceleration, jerk, and/or torque. For the motor controls of block 64, control and diagnostic functions are performed to maintain the required accuracy and trajectories of motor speed, acceleration, jerk, torque, and/or power to ensure that the proper power and torque are delivered. By monitoring the amount of corrective action taken by the closed-loop control of the speed, acceleration, jerk, torque, and/or power, the diagnostic functions of block 64 determines when the motor is not performing to acceptable specifications and notifies the driver to take the vehicle in for service. The control functions of block 64 determine the required current and/or voltage commands. Once the required current and/or voltage commands are determined, they are provided to block 66. Block 66 includes electronic power driver circuits that monitor the voltage and current in the windings of the motor and adjust the duty-cycle of power drivers to ensure that the proper voltage and current are delivered. By monitoring the amount of corrective action taken by the closed-loop control of the voltage or current, the diagnostic functions of block 66 determine when the motor or motor power drivers are not performing to acceptable specifications and notify the driver to take the vehicle in for service.

The operation of the estimation and prediction functions of block 29 for powertrain accessory control block 56 and accessory control actuator block 58 is analogous to the estimation, prediction, control, and diagnostic functions described above for a powertrain with an ICE and an electric motor. In addition, the operation of estimation and prediction (block 29) for control of other torque sources and sinks in block 60 and other control actuators in block 62 operates in similar fashion to blocks 56 and 58.

Referring to FIG. 2 and block 50, multiple sources and sinks of power can be coordinated and integrated to provide a seamlessly coordinated control of power or torque. For example, an internal combustion, engine, powertrain accessory loads, an electric motor, and a flywheel may be integrated and coordinated. Through the power torque control coordinator function of block 50, multiple sources and sinks of power are coordinated and integrated through an open architecture. Block 50 makes supervisory decisions as to which sources or sinks of power or torque to command and the command magnitudes to each torque source. Block 50 makes these decisions based on the properties and the state of each torque or power generator, while balancing the performance constraints of response, efficiency, capability, and other requirements such as noise, vibration, thermal limitations, speed limitations, and similar criteria.

Each torque or power generator is commanded to provide the desired and properly shaped acceleration, jerk, velocity, torque, and/or power trajectories contributing to delivering the properly shaped vehicle response trajectories. In order to accomplish this, the torque control coordinator of block 50 has available to it performance models of each power and torque source in block 29. The models are higher-level models that describe the performance of each of the torque sources in terms of their maximum and minimum torque or power capabilities and responsiveness. Accordingly, to ensure that the properly shaped vehicle response trajectories are achieved, block 50 determines which torque or power sources or sinks to command on or off and how much of each source or sink is required to achieve the desired performance subject to component performance constraints.

For example, in a hybrid propulsion system, under some conditions such as a torque reduction request from the traction control system, block 50 may determine that the best way to reduce the torque is to temporarily use the electric motor as a generator. Accordingly, the generator function of the motor rapidly imposes a load on the vehicle and provides a torque reduction over a short transient period for short traction loss events while the torque of the ICE is reduced to a lower level for a longer term traction loss event. An electric motor is used to initially handle rapid torque change requests and the ICE is coordinated with the electric motor to provide a longer-term torque reduction such that emissions are optimized. The torque reduction is coordinated such that the motor is switched to a generator mode rapidly. If the traction loss were sustained for a significant period of time, the generator load is reduced in a coordinated fashion with the reduction of the torque produced from the ICE. The ICE is able to reduce the torque level by adjusting the throttle. In order to satisfy emissions constraints, the electric motor covers the initial transient torque reduction while the torque reduction of the ICE is changed at a slower rate to minimize the impact on emissions.

The power transfer block 18 includes: a transmission control coordinator 68; a transmission clutch control block 70 for controlling clutch control actuators 72 such as solenoids; a torque converter clutch control block 74 to control clutch control actuators 76 such as solenoids or force motors. The power transfer function of block 18 appears to the power control integration unit of block 14 as a ratio servo device that delivers the appropriate shaped gear ratio trajectories and transfers the appropriately shaped torque, power, jerk, acceleration, and/or velocity trajectories to the output shaft of the powertrain.

The transmission control coordinator of block 68 determines what clutches need to be actuated to achieve the appropriate transmission ratio required to transfer the torque to the output shaft of the powertrain. Block 68 synchronizes the engagement and disengagement of the various clutches by sending commands to the transmission clutch controls of block 70 and the torque converter clutch controls of block 74. Block 68 contains capability models (high-level models of the capability of the clutches, such as torque capacity, speed limitations, temperature limits, and/or others) of the clutches and uses these models along with system performance constraints to determine, which clutches to control. The decision to control specific clutches more effectively is based on information from block 35, which provides information on the state of the clutches through state and parameter estimation and prediction algorithms. The algorithms in block 35 determine the current state of the clutches, which include the slip speed, temperature, torque capacity, friction coefficient, and other significant variables and parameters that define the capability of the clutches. This information allows block 68 to operate the transmission safely and effectively to deliver the torque or power requested.

Once the transmission torque controls of block 70 receive a command to actuate certain clutches that includes how much torque must be transmitted through the clutches, block 70 determines the amount of pressure to apply to the clutches in order to transfer the torque or power to the output shaft. Block 70 controls and coordinates the pressure rise on the on-coming clutch and the pressure decrease on the off-going clutch, such that the torque transfer from one clutch and set of gears to another is synchronized for good shift quality and clutch durability. To accomplish this control task more effectively, block 70 receives additional information about the state of the clutches from block 35. Block 35 provides estimated and predicted values of the state of critical variables and parameters, such as clutch pressure, temperature, friction coefficient, and/or other similar variables.

Block 70 further controls the slip speed profiles of the clutches to deliver the appropriately shaped profiles of torque, acceleration, jerk, and/or velocity during the shift. Block 70 uses feed forward and/or feedback controls to control the shift performance. If the desired profiles are not achieved, the closed-loop controls will adjust the clutch pressures as appropriate to deliver the desired shift performance. In addition, the controls of block 70 include adaptive feedback or learning algorithms that are used to improve the feed forward commands of the clutch pressures. Adaptive feedback minimizes the effort required by the closed-loop controls to adjust the clutch pressure during a shift and ensure that the shift quality is maintained throughout the life of the powertrain.

The amount of correction required by the closed-loop and adaptive controls is used by the diagnostic control functions of block 70 to determine when the transmission needs servicing. When the closed-loop and adaptive controls of the clutch pressures make large compensations for the hardware, then the diagnostic algorithms of block 70 may determine that the clutches are not performing to acceptable specifications and notify the driver to take the vehicle in for service. The function of the torque converter clutch controls in block 74, with the optional aid of the state and parameter estimation and prediction algorithms of block 35, operate in an analogous fashion to block 70.

The outputs of block 70 are commands of the desired trajectories of clutch pressures that are delivered by the clutch control actuators of block 72. Block 72 controls the clutch pressures by controlling actuators that regulate hydraulic, electric, and/or mechanical devices, which ensure that the properly shaped pressure trajectories are delivered to the clutches. For example, block 72 controls the position of a solenoid valve that adjusts the flow of hydraulic fluid through a spool valve to the clutch plates and results in the appropriate pressure being applied between the input and output plates of the clutch. The controls of block 72 comprise a feed forward and/or feedback system designed to control the position of the solenoid valve by regulating the voltage and current waveforms applied to the solenoid's coil. Power driver circuits are included in block 72 to ensure that the voltage and current waveforms are shaped appropriately to ensure that the solenoid controls the pressures as required.

Similar to the operation of other control and diagnostic functions described above, diagnostic controls are included in block 72 to determine if the solenoid position control and power driver circuits are operating properly by monitoring the amount of closed-loop feedback correction required by the position control and the amount of closed-loop feedback correction required by current or voltage control, respectively. By using separate control and diagnostic functions for the position and power driver control, the diagnostics are able to separate and isolate failures between the mechanical and electrical components. To accomplish the control and diagnostic functions of block 72 more effectively, block 72 receives additional information about the state of the solenoids an/or power driver circuits from block 35. Block 35 provides estimated and predicted values of the state of critical variables and parameters, such as solenoid position, temperature, friction coefficient, damping coefficient, natural frequencies, winding resistance, winding inductance, and/or other similar variables. Similarly, the function of the torque converter clutch actuator controls in block 76, with the aid of the state and parameter estimation and prediction algorithms of block 35, operates in an analogous fashion to block 72.

FIG. 2 further details control system the feedbacks 80(a-d) that move from right to left. These feedbacks 80 allow consistent and reliable performance over the lifetime of the vehicle powertrain 15. Each software module provides the information necessary to describe its current performance capabilities to the modules to the left of them as diagrammed in FIG. 2 by the dashed lines that point from right to left. The feedbacks 80 enable the higher-level modules on the left to avoid requesting performance that cannot be achieved. Although feedbacks 80 are only shown between neighboring blocks in FIG. 2, additional feedbacks that go beyond neighboring blocks are beneficial for the efficient operation of this powertrain control system 10. Similarly, the diagram in FIG. 2 shows signals moving from left to right between neighboring software blocks/modules. In general, it should be assumed that these signals and feedbacks 80 could be passed through the system to any block that needs the information even though a direct connection is not explicitly shown.

A further advantage of the software architecture of the present control system is that software architecture allows plug-and-play software modules within blocks 12, 14, 16, and 18 to have predefined functions and I/O that may easily be integrated into the software architecture of the present invention. By treating the powertrain control system as the modular structure described above, every module to the left of block 16 of the system treats block 16 as a torque or power servo that delivers the appropriately shaped trajectories of torque, jerk, acceleration, velocity, and/or power. The control systems surrounding block 16 perform independently of the source of torque or power and the technology used to produce it, as long as they are provided a high level model (capability model) of the performance of block 16. Any power generation control system unit may be plugged in for block 16 with minimal impact on the calibration and integration of the control algorithms to the left of block 16. Accordingly, a previously calibrated power generation unit control system may be plugged into the rest of the control system and function as intended with no or minimal calibration. All of the control systems surrounding block 16 integrate and function as intended with minimal calibration and integration effort. If market trends or technology trends change, it is possible to rapidly integrate a different power generation source (direct injection gasoline, diesel, series or parallel hybrid, electric, fuel cell, and/or any combination) into the vehicle propulsion control system with relatively little or no effort.

The plug and play configuration of the present system allows the power transfer unit of block 18 can be viewed by the rest of the system as a ratio servo device that delivers the appropriately shaped trajectories of torque, jerk, acceleration, velocity, and/or power. As described previously, the surrounding control system can operate independently of the technology used to perform the power transfer and requires only a high-level capability model of block 18 in terms of the parameters that define its performance capabilities and limitations. The independent operation of block 18 provides the ability to plug in any power transfer technology (automatic freewheeler, automatic clutch-to-clutch, manual, automated manual, dual input-clutch manual, continuously variable, infinitely variable, and/or other transmission systems) into a vehicle propulsion system with relatively minimal or no calibration or integration effort.

From the view of the vehicle control and integration unit of block 12, everything to the right of block 12 in the figures appears as a torque or power servo that delivers torque or power to the output of the transmission or the axle, such that block 12 delivers the appropriately shaped trajectories of torque, jerk, acceleration, velocity, and/or power. The vehicle control system can operate independently of the technology that produces the torque or power, provided that block 12 is provided with the appropriate parameters that characterize the high-level capability model of the propulsion system's performance and limitations.

From the vehicle control systems perspective, by partitioning the propulsion system as described above, a previously calibrated powertrain (propulsion) system can be plugged into a previously calibrated vehicle control system and have the total vehicle operate properly within the limitations of the powertrain with minimal or no calibration or integration effort. The plug and play capabilities of the present system provide the ability to mix and match previously calibrated vehicle and powertrain systems to provide a variety of vehicle performance and technologies to rapidly take advantage of changing market and technology trends. There is a minimal need or no need to recalibrate the way that the driver, and vehicle control subsystems (traction, braking, steering, suspension, stability, yaw, dynamics, and other vehicle control subsystems) interact with the propulsion system, assuming that the powertrain (or propulsion) system has been appropriately sized for the vehicle application.

In addition, the torque control coordinator of block 50 provides a similar opportunity for plug-and-play of torque and power generation technologies but at a much lower level in the system structure. Since block 50 integrates the various sources and sinks of torque or power through high level capability models that describe the performance capabilities and limitations of the various sources and sinks of torque or power, block 50 can control the power generation relatively independently of the technology used to generate the torque or power. This software structure provides the ability to mix and match previously calibrated torque or power control subsystems with minimal or no calibration or integration effort.

The concept of plug-and-play for the transmission controls coordinator unit of block 68 operates similarly to the function of block 50 for the power generation unit. Since block 68 integrates the various clutches through high level capability models that describe the performance capabilities and limitations of the various clutches, block 68 can control the power transfer relatively independently of the technology used to transfer the torque or power. This structure provides the ability to mix and match previously calibrated clutch control systems (devices to control the removal or application of torque or power) with minimal or no calibration or integration effort.

Plug-and-play can be extended even further to the lowest level of the system, if the control actuators (blocks 54, 58, 62, 66, 72, and 76) at the right most end of FIG. 2 are treated as servo-systems that deliver the desired physical variable. Blocks 54, 58, 62, 66, 72 and 76 can be viewed by the control system elements to their immediate left as performing according to a higher-level capability model that defines their performance and limitations. For example, one of the input commands to block 54 might be the desired value of the mass of air in the cylinder. This command is independent of the technology or hardware used to control the mass of air in the cylinder. The actuator controlled by block 54 could be an electronically controlled throttle, electro-hydraulically controlled valves, or any other actuator that can control the mass of air in the cylinder. As far as the engine torque control functions in block 52 are concerned, block 54 acts as a servo-system that controls the mass of air in the cylinder to the desired accuracy and according to the properly shaped trajectories necessary to deliver the desired torque.

The subsystems to the left in the Figures of the mass air control in block 54 need only to be provided with the parameters that define the high-level capability model of the actuator control system. If the actuator control system technology or hardware is changed, new control software for the actuator would be required in block 54 along with its calibration, and the calibration for its capability model. However, the actuator control system software can be plugged in and function properly (within its design limitations) with the rest of the system, although, the performance may be restricted or enhanced depending on the capabilities of the actuator control system. Accordingly, it would be possible to change the actuator control system (in blocks 54, 58, 62, 66, 72, and 76) with minimal or no calibration effort for the rest of the control system.

While this invention has been described in terms of some specific embodiments, it will be appreciated that other forms can readily be adapted by one skilled in the art. Accordingly, the scope of this invention is to be considered limited only by the following claims.

1. A coordinated torque control system for a vehicle comprising:
a powertrain controller, a vehicle control integration control module contained in said powertrain controller;
a powertrain control integration module communicating with said vehicle control integration control module;
a power generation and transfer module communicating with said powertrain control integration module; and
wherein said powertrain control integration module may be programmed independent of the powertrain control technology used in the vehicle.

2. The coordinated torque control system of claim 1, wherein said vehicle control integration module processes driver inputs to produce a torque command to said powertrain control integration module.

3. The coordinated torque control system of claim 1, wherein said vehicle control integration module processes vehicle subsystem inputs to produce a torque command to said powertrain control integration module.

4. The coordinated torque control system of claim 1 wherein said vehicle control integration module includes an estimation and prediction module, a control module, and a diagnostics module.

5. The coordinated torque control system of claim 1 wherein said vehicle control integration module includes a driver interpretation module to process driver inputs, a vehicle coordination module to process vehicle subsystem inputs and a driver and vehicle state and parameter estimation and prediction module.

6. The coordinated torque control system of claim 1 wherein said vehicle control integration module generates a shaped torque command.

7. The coordinate torque control system of claim 1 wherein said vehicle control integration module arbitrates intervention from vehicle subsystem inputs with driver inputs.

8. A modular powertrain control system for a vehicle comprising:
a controller;
vehicle control integration software contained in said controller, wherein said vehicle control integration software includes an estimation and prediction algorithm to generate a first power command;
powertrain control integration software contained in said controller, wherein said powertrain control integration software processes said first power command to generate a second power command; and
power generation control software contained in said controller, wherein said power generation control software process said second power command to control the power output of a vehicle powertrain.

9. The modular powertrain control system of claim 8, wherein said vehicle control integration software processes driver inputs and vehicle subsystem inputs.

10. The modular powertrain control system of claim 8, wherein said first power command amplitude is varied over time.

11. The modular powertrain control system of claim 8, wherein said first power command is selected from a plurality of stored waveforms (not necessarily stored as waveforms, but generated from transfer functions that would generate the waveforms), the selection of one of said plurality of stored waveforms, dependent on driver inputs and vehicle subsystem inputs.

12. The modular powertrain control system of claim 8, wherein said vehicle powertrain includes an internal combustion motor.

13. The modular powertrain control system of claim 8, wherein said vehicle powertrain includes an electric motor.

14. The modular powertrain control system of claim 8, wherein said vehicle powertrain includes a fuel cell.

15. A method of controlling a vehicle powertrain comprising:
providing a vehicle control module;
storing a plurality of torque waveform commands in said vehicle control module corresponding to a vehicle calibration;
processing driver inputs and vehicle subsystem inputs with an estimation and prediction algorithm to select a first torque command, said first torque command comprising at least one of said plurality of stored torque waveform commands;
processing said first torque command with a powertrain control integration algorithm to produce a second torque command; and
controlling a vehicle powertrain with said second torque command using a power generation control algorithm.
